(19) United States
(12) Patent Application Publication
(10) Pub. No.: US 2025/0378844 A1
(43) Pub. Date: Dec. 11, 2025

(54) Systems And Methods For Preprocessing Data For Audio Analysis

(71) Applicant: VoxEQ, Inc., Jacksonville, FL (US)

(72) Inventors: John W. Caven, III, Jacksonville, FL (US); Christopher K. Eveland, Nashville, TN (US)

(21) Appl. No.: 18/739,736

(22) Filed: Jun. 11, 2024

(51) Int. Cl. G10L 25/51; G06N 3/084; G06N 3/0895

(52) U.S. Cl. CPC G10L 25/51; G06N 3/084; G06N 3/0895

(57) ABSTRACT

The present disclosure provides for systems and methods for preprocessing data for use in audio analytics. An audio analytics system may comprise at least one artificial intelligence infrastructure that may be at least partially trained using an amount of training data, wherein the training data may be derived from a plurality of training sources, wherein each training source may comprise at least one type or form of sound or audio that comprises one or more sound waves. In some aspects, the training data may be preprocessed using one or more preprocessing methods or techniques, wherein a preprocessing technique may comprise any method, procedure, modification, or adjustment that may be applied to at least a portion of the training data such that the audio analytics system may be able to process or analyze the training data more efficiently or more effectively.

### BACKGROUND

If humans can process information to solve problems and make decisions, would it be possible to program machines to do the same? This was the question that guided Alan Turing, the founder of computer science, when he researched whether machines could imitate human conversation. Since then, the advancement of computer technologies and artificial intelligence (“AI”) has developed at a rapid pace, with AI now playing an integral role in the everyday lives of people around the world as over 90% of leading businesses invest in its use, looking to enhance their output and data analysis, automate their processes, and enhance the overall consumer experience.

AI is the design of machines to simulate human intelligence and mimic human behavior. A subdivision of AI, machine learning, is the practice of using algorithms that dissect data, learn from it, and use it to make predictions about the world. As a conventional machine learning system receives and digests more information, the accuracy of its predictions increases; therefore, it is very important for the model to be continuously learning. Because of this importance, machine learning pipelines have been developed to streamline the process of teaching AI systems by automating the process by which an AI system receives data.

The first stage of any machine learning pipeline is the preprocessing phase, whereby raw data is cleaned and transformed into quantifiable features. More specifically, this is when raw data is gathered and merged into a single framework that can be understood and analyzed by the machine learning model. In this early stage, it is incredibly important to collect good data to properly train the AI system. Even the most powerful algorithms will perform poorly when trained with bad data obtained in the preprocessing phase.

There are many issues one may encounter while preprocessing data, such as the collection of irrelevant data, noisy data, duplicate data, data in unacceptable formats, data with too many dimensions, and data with too many categories. With regard to the preprocessing of audio data, the goal is to identify and extract the important relevant information from an audio file, a difficult task that only becomes more challenging as the number of collected audio sources increases. However, a very large amount of data must be gathered to properly train the AI system to recognize and understand important features from these audio files, and so a tremendous amount of raw data must be collected.

This is the greatest barrier to optimizing the preprocessing of audio data sets as training data are difficult to filter through and present to machine learning models in a way that produces reliable and useful results. Sources of good audio data exist, but a pipeline that can access such sources to collect the desired adequate abundance of useful raw data does not. This creates a substantial barrier to significantly increasing the capabilities of AI technology and machine learning.

### SUMMARY OF THE DISCLOSURE

What is needed are systems and methods for preprocessing data for use in audio analysis that enables an audio analytics system to execute at least one operation on one or more of a nearly infinite number of sound wave types, configurations, and combinations. Systems and methods for preprocessing data for use in audio analysis in a continuous and/or on-demand fashion are also desired.

The present disclosure provides systems and methods for preprocessing data for an audio analytics system. In some embodiments, the audio analytics system may comprise one or more audio sources. In some implementations, the audio analytics system may comprise one or more training sources. In some aspects, the audio analytics system may comprise at least one artificial intelligence infrastructure that may be at least partially trained using an amount of training data, wherein the amount of training data may be derived from a plurality of training sources, wherein each of the plurality of training sources may comprise at least one type or form of sound or audio that comprises one or more sound waves. In some aspects, the training data may be preprocessed using one or more preprocessing methods or techniques. In some non-limiting exemplary embodiments, a preprocessing technique may comprise any method, procedure, modification, or adjustment that may be applied to at least a portion of the training data such that the audio analytics system may be able to process or analyze the training data more efficiently or more effectively.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary audio analytics system, according to some embodiments of the present disclosure.

FIG. 2 illustrates an exemplary audio analytics system, according to some embodiments of the present disclosure.

FIG. 3 illustrates an exemplary audio analytics system, according to some embodiments of the present disclosure.

FIG. 4 illustrates an exemplary potential origin characteristic identified by an audio analytics system, according to some embodiments of the present disclosure.

FIG. 5A illustrates an exemplary audio analytics system comprising a training source, according to some embodiments of the present disclosure.

FIG. 5B illustrates an exemplary audio analytics system comprising two or more training sources, according to some embodiments of the present disclosure.

FIG. 6A illustrates an exemplary audio analytics system comprising two or more training sources, according to some embodiments of the present disclosure.

FIG. 6B illustrates an exemplary audio analytics system comprising two or more training sources, according to some embodiments of the present disclosure.

FIG. 7A illustrates an exemplary audio analytics system comprising a training source and an audio capture device, according to some embodiments of the present disclosure.

FIG. 7B illustrates an exemplary audio analytics system comprising a training source and an audio capture device, according to some embodiments of the present disclosure.

FIG. 7C illustrates an exemplary audio analytics system comprising a training source and an audio capture device, according to some embodiments of the present disclosure.

The Figures are not necessarily drawn to scale, as their dimensions can be varied considerably without departing from the scope of the present disclosure.

### DETAILED DESCRIPTION

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Audio Characteristic: as used herein refers to at least one aspect of an audio source. In some aspects, an audio characteristic may comprise volume, tone, rhythm, inflection, pitch, base, frequency, or one or more image processing analytics, as non-limiting examples.
Origin Characteristic: as used herein refers to at least one physical, mental, or emotional characteristic associated with an origin of at least one audio source. In some aspects, an origin characteristic may comprise an age, age range, height, weight, gender, sex, hormonal development, race, ethnicity, species, breed, identification, emotional state, mental state, fatigued status, or level of neurological impairment of an origin, as non-limiting examples.
Audio Source: as used herein refers to any auditory sound emitted by at least one origin, wherein an origin may comprise the originator of the auditory sound. In some non-limiting exemplary embodiments, an audio source may comprise a human voice. In some aspects, by way of example and not limitation, an audio source may comprise a previously emitted auditory sound stored within at least one storage medium. In some aspects, by way of further example and not limitation, an audio source may at least partially comprise a live audio stream.
Audio Capture Device: as used herein refers to any device used to capture or receive at least one audio source. By way of example and not limitation, an audio capturing device may comprise a microphone, camera, or a recording device.
Operation: as used herein refers to any action that may be executed on at least one audio source by at least one computing device. By way of example and not limitation, an operation may comprise any function, process, procedure, algorithm, artificial intelligence application, or machine learning process that may be used to at least partially analyze at least one audio source. By way of further example and not limitation, an operation may be executed during the performance of a neural network or support vector machine.
Parameter: as used herein refers to any element that may influence an operation executed by at least one computing device. In some aspects, a parameter may comprise one or more weights, one or more biases, one or more values, and/or one or more inputs.
Embedding: as used herein, refers to a condensed data set comprising one or more origin characteristics at least partially derived from at least one audio source. In some embodiments, an embedding may comprise a resultant data set produced after an audio source is processed by at least one artificial intelligence infrastructure. In some implementations, an embedding may comprise audio source data that excludes information that is irrelevant to any origin characteristics of an origin of an audio source, such as, for example and not limitation, the content of one or more spoken sounds or background noise, as non-limiting examples.

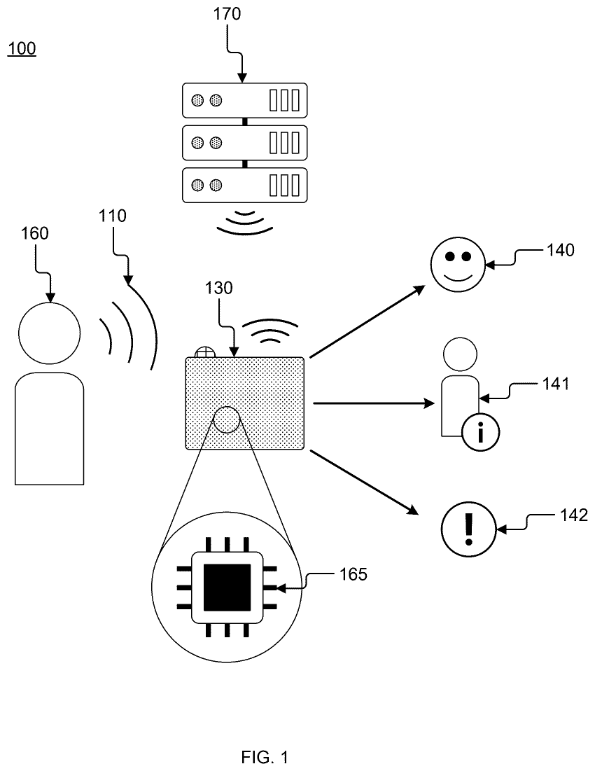

Referring now to FIG. 1, an exemplary audio analytics system 100, according to some embodiments of the present disclosure, is illustrated. In some aspects, the audio analytics system 100 may comprise at least one audio source 110. In some implementations, the audio analytics system 100 may comprise at least one audio capture device 130. In some implementations, the audio analytics system 100 may be configured to identify one or more potential origin characteristics 140, 141, 142 associated with an origin 160 of the audio source 110, wherein the potential origin characteristics 140, 141, 142 may be presented to at least one user of the audio analytics system 100. In some embodiments, the audio capture device 130 may at least partially comprise at least one computing device. In some implementations, the audio capture device 130 may be communicatively coupled to at least one computing device, such as via a wireless connection or a hardwired connection, as non-limiting examples. In some non-limiting exemplary embodiments, the audio capture device 130 may at least partially comprise or may be communicatively coupled to at least one computing device that comprises one or more of: a central processing unit (“CPU”), a graphics process unit (“GPU”), an edge computing device, a system on a chip, a tensor core, a headset, a virtual reality device, an augmented reality device, an on-board vehicle computer, a smartphone, a smart watch, a laptop computer, a tablet computer, a desktop computer, a gaming console, a smart speaker, or a hearing aid, as non-limiting examples. In some aspects, the audio capture device 130 may comprise at least one of: a peripheral device and a sensing device.

In some implementations, the audio capture device 130 may be configured to receive at least one audio source 110. By way of example and not limitation, the audio capture device 130 may receive the audio source 110 via at least one input element, such as a microphone or network or broadcast connection, as non-limiting examples. In some aspects, the audio analytics system 100 may be configured to execute at least one operation on the audio source 110, wherein execution of the at least one operation may allow the audio analytics system 100 to identify one or more potential origin characteristics 140, 141, 142 associated with an origin 160 of the audio source 110. By way of example and not limitation, potential origin characteristics 140, 141, 142 may comprise a physical, mental, or emotional status associated with the origin 160 of the audio source 110. By way of further example and not limitation, potential origin characteristics 140, 141, 142 may comprise one or more of: an age, an age range, a height, a height range, a length, a length range, a weight, a weight range, a gender, a sex, a hormonal development, a race, an ethnicity, a species, a breed, or an identification of the origin 160 of the audio source 110.

In some aspects, the audio analytics system 100 may comprise at least one storage medium 165. In some non-limiting exemplary embodiments, the storage medium 165 may at least partially comprise an amount of volatile memory for streaming data. In some implementations, the storage medium 165 may comprise one or more parameters that may be used or referenced during the execution of the operations on the audio source 110. In some non-limiting exemplary embodiments, the parameters may comprise one or more weights, biases, or similar values, modifiers, or inputs. In some aspects, at least a portion of the parameters may be adjustable to improve the accuracy of the potential origin characteristics 140, 141, 142 identified for the origin 160 of the audio source 110.

In some implementations, the audio analytics system 100 may comprise at least one artificial intelligence infrastructure. In some non-limiting exemplary embodiments, the artificial intelligence infrastructure may be communicatively coupled to the audio capture device 130. In some implementations, the audio capture device 130 may comprise the artificial intelligence infrastructure. In some aspects, the artificial intelligence infrastructure may be configured to at least partially execute the at least one operation on the audio source 110. In some embodiments, the artificial intelligence infrastructure may be at least partially configured within one or more external or remote computing devices or servers 170 that may be communicatively coupled to the audio capture device 130 via at least one network connection, such as, for example and not limitation, via a connection to the global, public Internet or via a connection to a local area network (“LAN”). In some non-limiting exemplary implementations, the artificial intelligence infrastructure may be stored within one or more external or remote computing devices or servers 170 that may be communicatively coupled to the audio capture device 130 directly without using any network connection, such as, for example and not limitation, in a disconnected edge computing environment. By way of example and not limitation, the artificial intelligence infrastructure may comprise at least one of: a neural network, a deep neural network, a convolutional neural network, or a support vector machine. By way of further example and not limitation, the artificial intelligence infrastructure may be at least partially configured within at least one computing device that comprises one or more of: a central processing unit (“CPU”), a graphics processing unit (“GPU”), an edge computing device, a system on a chip, or a tensor core, as non-limiting examples.

In some aspects, the audio analytics system 100 may comprise a plurality of artificial intelligence infrastructures. In some non-limiting exemplary embodiments, the audio analytics system 100 may comprise a first artificial intelligence infrastructure and a second artificial intelligence infrastructure. In some implementations, the first artificial intelligence infrastructure may be configured to at least partially execute a first at least one operation on the audio source 110 using a first set of parameters and the second artificial intelligence infrastructure may be configured to at least partially execute a second at least one operation on the audio source 110 using a second set of parameters.

In some embodiments, the first artificial intelligence infrastructure of the audio analytics system 100 may be configured to identify one or more audio characteristics of the audio source 110. In some implementations, the audio characteristics may be identified via a first at least one operation that may be executed on the audio source 110 and a second at least one operation may be executed on the identified audio characteristics of the audio source 110 to identify one or more potential origin characteristics 140, 141, 142 associated with an origin 160 of the audio source 110. In some aspects, at least one operation may be executed directly on the audio source 110 to identify one or more potential origin characteristics 140, 141, 142 without first identifying any audio characteristics. In some implementations, one or more audio characteristics may be identified or determined for the audio source 110 by one or more processes or analytical methods that do not comprise executing at least one operation on the audio source 110. By way of example and not limitation, audio characteristics of the audio source 110 may comprise one or more of: volume, tone, rhythm, inflection, pitch, base, vibrational frequency, image processing analytics, or similar aspects of the audio source 110. By way of further example and not limitation, potential origin characteristics 140, 141, 142 may comprise one or more physical, mental, or emotional features or states of an origin 160 of the audio source 110. In some non-limiting exemplary embodiments, the first at least one operation and the second at least one operation may be executed by the same artificial intelligence infrastructure.

In some embodiments, an audio source 110 may comprise one or more audio characteristics that may be captured by at least one audio capture device, wherein the audio characteristics may be identified or determined via the audio analytics system 100. In some aspects, the audio source 110 may comprise audio characteristics of one or more sound waves produced by the vibrations of one or more vocal cords, the sound of air passing in or out of a human or animal mouth or nose during breathing processes, wheezing or coughing sounds associated with the functioning of lungs, a resonance occurring in one or more nasal cavities, or any similar sounds, as non-limiting examples. In some aspects, the audio source 110 may comprise one or more audio characteristics of one or more sound waves that may be directly emitted by a human or animal or one or more reproduced human or animal sounds. By way of example and not limitation, a reproduced sound may comprise one or more live or previously recorded sounds that may be output by at least one audio emitting device instead of being directly emitted from a human or animal. By way of further example and not limitation, in some embodiments, the audio emitting device that produces one or more reproduced sounds may comprise at least one speaker.

As a non-limiting illustrative example, the audio from a conversation between two or more people may be captured, recorded, and processed or analyzed by the audio analytics system 100. In some aspects, the tone, cadence, inflection, and other audio characteristics of the vocal sounds produced by the individuals in the conversation may be captured via at least one audio capture device 130 in the form of, for example and not limitation, a microphone associated with a portable computing device, such as a smartphone or tablet computer that may be proximate to the individuals such that the microphone may be able to detect the conversation.

In some aspects, the audio source 110 may be captured by the audio capture device 130 and used by the audio analytics system 100 to determine at least one potential origin characteristic 140, 141, 142 related to an origin 160 of the audio source 110. By way of example and not limitation, a potential origin characteristic 140, 141, 142 of an origin 160 may comprise one or more of: a physical, mental, or emotional condition of the origin 160 of the audio source 110. By way of further example and not limitation, a potential origin characteristic 140, 141, 142 may comprise at least one of: an age, an age range, a height, a height range, a length, a length range, a weight, a weight range, a gender, a sex, a hormonal development, a race, an ethnicity, a species, a breed, or an identification of the origin 160 of the audio source 110.

As a non-limiting illustrative example, the audio source 110 may comprise a person's voice, which may be captured and processed or analyzed to identify or determine one or more potential origin characteristics 140, 142 regarding the emotional or mental state of the person comprising the origin 160 of the audio source 110. In some implementations, this identification may at least partially comprise the audio analytics system 100 performing or executing at least one operation on the audio source 110. In some aspects, the audio analytics system 100 may comprise at least one storage medium 165, wherein the storage medium 165 may comprise one or more parameters that may be utilized or referenced to at least partially execute the at least one operation on the captured audio source 110. By way of example and not limitation, the parameter(s) within the storage medium 165 may comprise one or more weights, biases, or similar values, modifiers, or inputs that may at least partially influence any resulting output(s) from the at least one operation. In some non-limiting exemplary embodiments, at least a portion of the one or more parameters may be adjustable to modify the accuracy of the potential origin characteristics 140, 141, 142 identified via the execution of the at least one operation on the captured audio source 110.

In some implementations, an audio source 110 may be captured by at least one audio capture device 130. The captured audio source 110 may then be used by the audio analytics system 100 to identify at least one potential origin characteristic 141 associated with the audio source 110. As a non-limiting illustrative example, the audio source 110 may comprise a person's voice, which may be captured and processed or analyzed to identify or determine one or more potential origin characteristics 141 related to the origin 160 of the audio source 110 such as, by way of example and not limitation, one or more physical attributes of the origin 160, i.e., the person speaking. In some embodiments, the audio capture device 130 may comprise at least one storage medium 165, wherein the storage medium 165 may comprise one or more adjustable parameters that may be utilized or referenced during execution of the at least one operation on the captured audio source 110.

In some non-limiting exemplary embodiments, the audio analytics system 100 may comprise one or more parameters that may allow the audio analytics system 100 to identify one or more potential origin characteristics 140, 141, 142 that may be affected by differences in sound waves produced by the vocal cords of humans or animals of different genders, sexes, hormonal developments, ages, heights, lengths, weights, species, breeds, races, or ethnicities, as non-limiting examples, as the length, stiffness, vibrational frequency, and/or resonance of vocal cords may be affected by any or all of these factors, thereby causing the vocal cords of different humans or animals to produce sound waves that differ in at least one aspect. By way of example and not limitation, a human voice may be captured and processed or analyzed to identify potential origin characteristics 140, 141, 142 that indicate that a person is likely a 6′5 tall, 55-year-old male that weighs approximately 200 pounds.

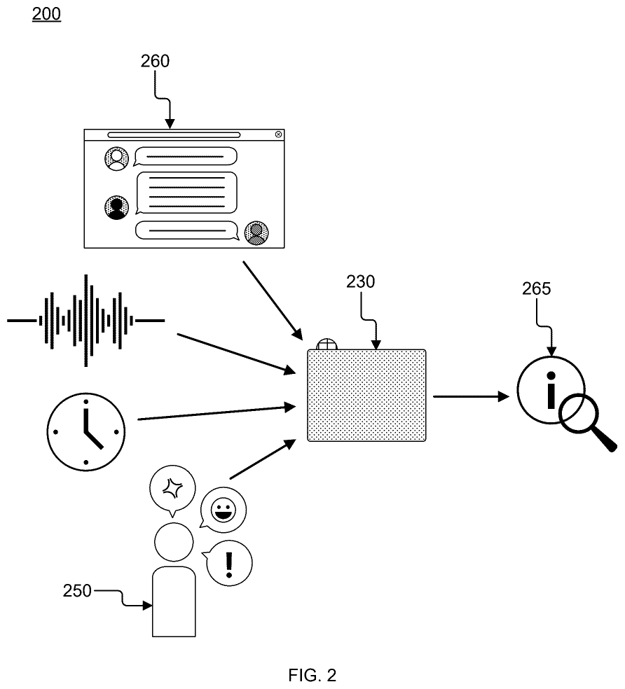

Referring now to FIG. 2, an exemplary audio analytics system 200, according to some embodiments of the present disclosure, is illustrated. In some aspects, the audio analytics system 200 may comprise at least one training source 260. In some implementations, the audio analytics system 200 may comprise at least one audio capture device 230. In some aspects, the audio analytics system 200 may be configured to extract at least one datum of training data 265 from the training sources 260. In some embodiments, the training data 265 may be propagated through at least one artificial intelligence infrastructure as part of a machine learning process to enable the artificial intelligence infrastructure to identify one or more audio characteristics and/or one or more potential origin characteristics associated with each training source 260. In some non-limiting exemplary embodiments, the training data 265 may be at least temporarily stored within at least one database or similar storage medium associated with or communicatively coupled to the audio analytics system 200.

In some embodiments, the audio analytics system 200 may comprise at least one audio capture device 230. In some aspects, the audio analytics system 200 may comprise at least one training source 260. In some implementations, the audio analytics system 200 may comprise at least one datum of training data 265 that may be at least partially derived from the training source 260. In some embodiments, the audio analytics system 200 may use the audio capture device 230 to capture and process or analyze the training source 260 to obtain the training data 265.

In some implementations, the training source 260 may be emitted from any origin 250 or combination of origins 250, such as, but not limited to, any human, animal, object, or phenomenon capable of producing sound. In some non-limiting exemplary embodiments, one or more training sources 260 may be received by the audio analytics system 200 via one or more existing communication infrastructures, wherein one or more components or groups of components within the communication infrastructure(s) may be used by the audio analytics system 200 as audio capture device(s) 230. By way of example and not limitation, the audio analytics system 200 may utilize one or more servers that host a network-based communication platform (e.g., a social media network or virtual gaming environment), one or more communication services operating on one or more mobile computing devices (such as, for example and not limitation, the WhatsApp® service available from Meta of Menlo Park, CA), one or more microphones or speakers associated with a broadcast system, one or more radio signals, or one or more microphones or speakers associated with any electronic device (e.g., smartphones, televisions, radios, etc.) as audio capture device(s) 230. In some aspects, by utilizing existing communication infrastructures and components, the audio analytics system 200 may be able to capture a myriad of training sources 260 from numerous locations to derive a significant amount of training data 265 that may ultimately improve the ability of the audio analytics system 200 to identify one or more potential origin characteristics for one or more subsequently received audio sources.

In some implementations, the audio analytics system 200 may be trained via at least one semi-supervised machine learning process. In some aspects, the semi-supervised machine learning process may utilize one or more pseudo-labeling techniques. In some non-limiting exemplary embodiments, each potential origin characteristic identified for the training data 265 derived from training sources 260 received by the audio analytics system 200 may be compared to at least one of: a known (or labeled) origin characteristic associated with the training data 265 or an estimated (or pseudo-labeled) origin characteristic associated with the training data 265. In some aspects, this comparison may allow the audio analytics system 200 to determine if each identified potential origin characteristic of the training data 265 is accurate or inaccurate. In some implementations, if an identified potential origin characteristic is determined to be inaccurate, the audio analytics system 200 may perform one or more calculations to assess the degree or nature of the inaccuracy. In some aspects, the data resulting from this assessment may be directed back through the artificial intelligence infrastructure via at least one backpropagation algorithm. In some non-limiting exemplary embodiments, the at least one backpropagation algorithm may adjust the one or more weights, biases, or other parameters of the audio analytics system 200 to generate more accurate results for subsequently received training data 265 obtained from one or more training sources 260. In some aspects, the utilization of at least one semi-supervised machine learning process may enable the audio analytics system 200 to process a greater amount of training data 265 from more training sources 260.

In some aspects, at least a portion of the training data 265 derived from the training sources 260 received by the audio analytics system 200 may be at least partially augmented. In some non-limiting exemplary embodiments, augmenting the training data 265 may at least partially comprise replicating and applying one or more audio quality influencers to the training sources 260, wherein the one or more audio quality influencers may comprise one or more factors that may affect the quality of audio comprising each training source 260. By way of example and not limitation, an audio quality influencer may comprise compression applied to audio sources transmitted via at least one cellular telephone system or via one or more user communication services operating on one or more mobile computing devices (such as the WhatsApp®® service available from Meta of Menlo Park, CA, a social media network, or a virtual gaming environment, as non-limiting examples).

In some implementations, the determination of the accuracy of the one or more potential origin characteristics identified for each training source 260 received by the audio analytics system 200 may at least partially comprise the execution of at least one loss function. In some aspects, the loss function may be configured to simultaneously determine classification loss and regression loss for each identified potential origin characteristic such that the audio analytics system 200 may be trained to accurately predict at least one class and/or at least one distribution range for one or more of the potential origin characteristics. By way of example and not limitation, the audio analytics system 200 may be trained to predict an age (e.g., an animal is 10 years old) as well as an age range (e.g., a human is between 20 and 30 years old) for an origin 250 of an audio source. In some non-limiting exemplary embodiments, the loss function may at least partially comprise at least one linear quadratic estimation algorithm. The loss function may at least partially comprise a semi-supervised machine learning process with pseudo-labeling techniques.

In some embodiments, the audio analytics system 200 may comprise one or more databases, servers, and/or other storage media that may collectively serve as a library of previously captured, previously recorded, or currently streamed training sources 260. For example, a database may comprise at least one internal library of stored training sources 260 within or integrated with an audio capture device 230 and/or the database may comprise at least one external server to which the audio capture device 230 may be connected by means of at least one network connection, such as the global, public Internet, or a closed local area network (“LAN”), wherein the network may be used by the audio analytics system 200 to implement a sequential process for scanning the network connections to obtain training data 265 and other information from various training sources 260, such as one or more remote audio capture devices 230 or one or more external privately maintained or publicly available databases.

As a non-limiting illustrative example, a database may comprise at least one server that facilitates access to a variety of training sources 260 and audio information pertaining to each training source 260 that may be used to train at least one artificial intelligence infrastructure of the audio analytics system 200 to determine at least one potential origin characteristic of at least one captured audio source which may, by way of example and not limitation, provide a confirmation or verification of the identity of the origin 250 of the audio source or may make a determination regarding at least one of: an emotional state, one or more physical characteristics, or a mental state of the origin 250 of the captured audio source.

In some implementations, the audio analytics system 200 may be trained to identify one or more potential origin characteristics for an origin 250 of an audio source that comprise an indication of potential fraudulent behavior being engaged in by the origin 250. In some aspects, by having previously processed or analyzed a plurality of training sources 260 comprising recordings or data streams of origins 250 engaging in fraudulent activities, the audio analytics 200 may be configured to receive an audio source and identify potential origin characteristics for the origin 250 of the audio source that comprise an indication of whether the origin 250 is likely to be committing fraud, wherein the indication may be presented via a user interface. In some non-limiting exemplary embodiments, the audio analytics system 200 may generate and present one or more scores indicating an estimated accuracy or likelihood that the determination of fraud is correct, accurate, or true.

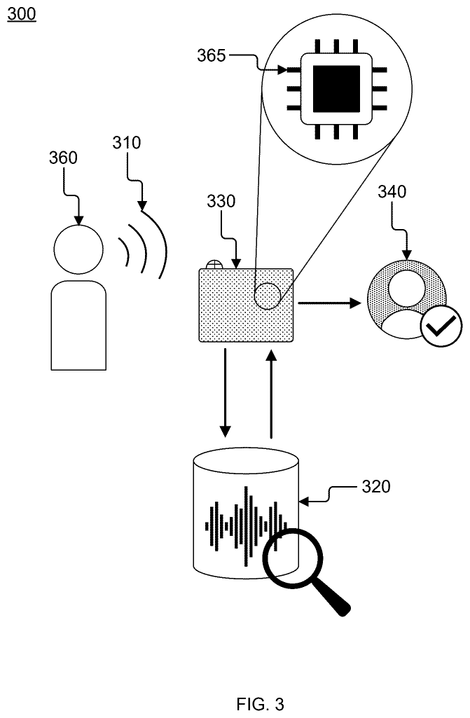

Referring now to FIG. 3, an exemplary audio analytics system 300, according to some embodiments of the present disclosure, is illustrated. In some embodiments, the audio analytics system 300 may comprise at least one audio source 310. In some implementations, the audio analytics system 300 may comprise at least one database 320 and/or at least one storage medium 365. In some embodiments, the database 320 may be physically and/or logically separate from the storage medium 365. In some aspects, the audio analytics system 300 may be trained and configured to identify or determine and subsequently present one or more origin characteristic results 340 associated with an origin 360 of the audio source 310. In some implementations, the origin characteristic results 340 may comprise one or more origin characteristics themselves or one or more results of a comparison between one or more potential origin characteristics and one or more expected origin characteristics, which may be helpful, for example and not limitation, when assessing potential fraudulent behavior.

In some embodiments, an audio capture device 330 may at least partially comprise at least one computing device. In some implementations, the audio capture device 330 may be communicatively coupled to at least computing device, such as via a wireless connection or a hardwired connection, as non-limiting examples. In some aspects, the audio capture device 330 may comprise at least one of: a peripheral device and a sensing device.

In some aspects, one or more audio characteristics of one or more sound waves produced by an audio source 310 may be captured by at least one audio capture device 330 and subsequently processed or analyzed by the audio analytics system 300. In some implementations, the audio capture device 330 may be communicatively coupled to at least one artificial intelligence infrastructure. In some non-limiting exemplary embodiments, the audio capture device 330 may comprise at least one artificial intelligence infrastructure. In some aspects, the artificial intelligence infrastructure may be configured to at least partially execute at least one operation on a captured audio source 310. In some implementations, the artificial intelligence infrastructure may be stored within one or more external or remote computing devices or servers that may be communicatively coupled to the audio capture device 330 via at least one network connection or via at least one direct connection. By way of example and not limitation, in some aspects, the artificial intelligence infrastructure may comprise at least one of: a neural network, a deep neural network, a convolutional neural network, and a support vector machine.

In some aspects, the audio capture device 330 may comprise at least a portion of or may be integrated with one or more audio-based products, such as a telephone system, smartphone, laptop computing device, hearing aid or broadcast system, as non-limiting examples. By way of example and not limitation, an audio capture device 330 may comprise a smartphone programmed with one or more software applications that allow the smartphone to capture and process or otherwise analyze, for example and not limitation, a telephonic communication or other vocal interaction occurring between at least two people, at least two animals, or between at least one person and an audio recording, as non-limiting examples.

In some non-limiting exemplary implementations, an audio source 310 may be captured by at least one audio capture device 330 and cross-referenced with information or data contained in at least one database 320. In some aspects, the database 320 may be communicatively coupled to the audio capture device 330, such as via at least one network connection, or the audio capture device 330 may at least partially comprise the database 320. In some implementations, one or more audio characteristics of the audio source 310 may be identified by the audio analytics system 300 via execution of a first at least one operation on the captured audio source 310 and a second at least one operation may be executed on the identified audio characteristic(s) to identify one or more potential origin characteristics associated with an origin 360 of the audio source 310. In some non-limiting exemplary embodiments, the first at least one operation may be at least partially executed by a first artificial intelligence infrastructure utilizing a first set of one or more parameters and the second at least one operation may be at least partially executed by a second artificial intelligence infrastructure utilizing a second set of one or more parameters. In some implementations, the first and the second at least one operation may be at least partially executed by the same artificial intelligence infrastructure using the same or different sets of one or more parameters.

In some non-limiting exemplary embodiments, the database 320 may comprise one or more physical memory components configured internally within the audio capture device 330, or the database 320 may comprise one or more external databases or servers to which the audio capture device 330 may be communicatively coupled, such as via wireless connectivity or via a direct wired connection. In some aspects, the database 320 may comprise at least one datum associated with one or more expected origin characteristics related to an origin 360 of a captured audio source 310 that may be compared to one or more potential origin characteristics identified for the origin 360 of the audio source 310 by the audio analytics system 300. In some implementations, the database 330 may comprise a plurality of stored sound waves in the form of, for example and not limitation, audio samples from one or more previously stored audio sources 310 to use as a comparison for a captured audio source 310.

In some non-limiting exemplary implementations, the audio analytics system 300 may be configured to perform at least one comparative analysis to determine one or more origin characteristics results 340 for an audio source 310. In some non-limiting exemplary embodiments, the comparative analysis may at least partially comprise a direct or indirect comparison comprising one or more identified potential origin characteristics associated with an origin 360 of an audio source 310 that may be cross-referenced with one or more expected origin characteristics for the origin 360 that may be stored within the database 320. In some aspects, at least a portion of the expected origin characteristics may be at least partially identified from one or more audio samples previously stored within the database 320.

As a non-limiting illustrative example, a phone call between a person and a bank may be captured using at least one audio capture device 330, and the audio capture device 330 may facilitate the execution of a first at least one operation on a data stream comprising the caller's voice to identify one or more audio characteristics of the voice, after which a second at least one operation may be executed on the data stream to identify one or more potential origin characteristics of the caller. In some aspects, the identified potential origin characteristics may be cross-referenced against one or more expected origin characteristics within at least one database 320 to attempt to verify the identity of the caller. In some non-limiting exemplary implementations, the caller's voice may be directly compared to a plurality of voice recordings stored within the database 320 such that the audio analytics system 300 may attempt to match the caller's voice to at least one previously-recorded voice sample obtained from the caller. For example, the database 320 may comprise one or more recordings of previous calls the caller made to the bank or other institutions, and the audio analytics system 300 may compare the caller's voice with those stored phone conversations to determine whether the caller is the same person as in the recordings. In some embodiments, the results of this determination may be presented via a user interface associated with the audio capture device 330 or another electronic or computing device associated with the audio analytics system 300.

As an additional non-limiting illustrative example, an individual may call a bank or other financial institution and claim to be the owner of one or more accounts. The bank records may indicate that the owner of the relevant account is a 65-year-old female, wherein the age and gender data may comprise actual expected origin characteristics of the account owner. In some aspects, the audio analytics system 300 may execute at least one operation on the data stream comprising the caller's voice to identify one or more potential origin characteristics associated with the caller. In some implementations, the audio analytics system 300 may then make a comparative determination between the identified potential origin characteristics of the caller's voice and the expected origin characteristics comprising the age and gender of the actual account holder stored within the database 320 to determine origin characteristic results 340 that may indicate whether the caller may be a 65-year-old female, wherein a negative determination may indicate that the caller may be engaging in fraudulent behavior. In some aspects, the origin characteristic results 340, as well as the assessment of fraud, may be presented via at least one user interface, which may enable an employee of the bank to quickly ascertain whether a risk of fraud is associated with the current call.

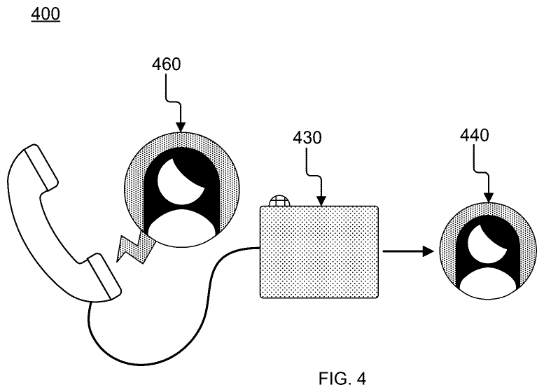

Referring now to FIG. 4, an exemplary potential origin characteristic 440 identified by an audio analytics system 400, according to some embodiments of the present disclosure, is illustrated. In some aspects, the audio analytics system 400 may comprise at least one training source 460. In some implementations, the audio analytics system 400 may comprise at least one audio capture device 430. In some embodiments, the audio analytics system 400 may be configured to identify and present one or more potential origin characteristics 440 associated with an origin of the training source 460.

By way of example and not limitation, a training source 460 may comprise a person's voice on a phone call, wherein the audio capture device 430 may be integrated with or communicatively coupled to the phone, either wirelessly or via a direct wired connection, to capture the person's voice. In some non-limiting exemplary embodiments, the audio capture device 430 may comprise the phone itself, which may comprise a smartphone, as a non-limiting example. In some aspects, the audio capture device 430 may comprise or may be communicatively coupled to at least one storage medium, wherein the storage medium may comprise one or more parameters that may be utilized to at least partially execute at least one operation on the captured training source 460 that may, among other things, enable the audio analytics system 400 to learn to determine or verify the identity of the speaker. By way of example and not limitation, the parameter(s) within the storage medium may comprise one or more weights, biases, or similar values, modifiers, or inputs. In some non-limiting exemplary embodiments, at least a portion of the parameter(s) may be adjustable to modify the accuracy of one or more potential origin characteristics 440 that may be identified via the execution of the at least one operation on the training source 460.

In some implementations, the audio capture device 430 may be communicatively coupled to at least one artificial intelligence infrastructure. In some non-limiting exemplary embodiments, the audio capture device 430 may comprise at least one artificial intelligence infrastructure. In some aspects, the artificial intelligence infrastructure may be configured to at least partially execute the at least one operation on the captured training source 460. By way of example and not limitation, in some aspects, the artificial intelligence infrastructure may comprise at least one of: a neural network, a deep neural network, a convolutional neural network, and a support vector machine.

In some aspects, the audio analytics system 400 may be configured to identify one or more audio characteristics of the captured training source 460. In some implementations, the audio characteristic(s) may be identified via execution of a first at least one operation on the received training source 460 and a second at least one operation may be executed on the identified audio characteristic(s) to identify the potential origin characteristic(s) 440 associated with the origin of the training source 460.

In some non-limiting exemplary embodiments, the audio analytics system 400 may be configured to access one or more telecommunications devices, such as smartphones or telephones, associated with personal or professional use. For instance, the audio analytics system 400 may be configured to receive and capture audio via one or more telephones associated with a call center or via one or more personal smartphones, as non-limiting examples. By using these and other different types of telecommunications devices as audio capture devices 430, the audio analytics system 400 may derive a significant amount of training data from a multitude of training sources 460 that may enable the audio analytics system 400 to become better adept at identifying one or more potential origin characteristics 440, such as, for example and not limitation, distinguishing between different identities for different training sources 460.

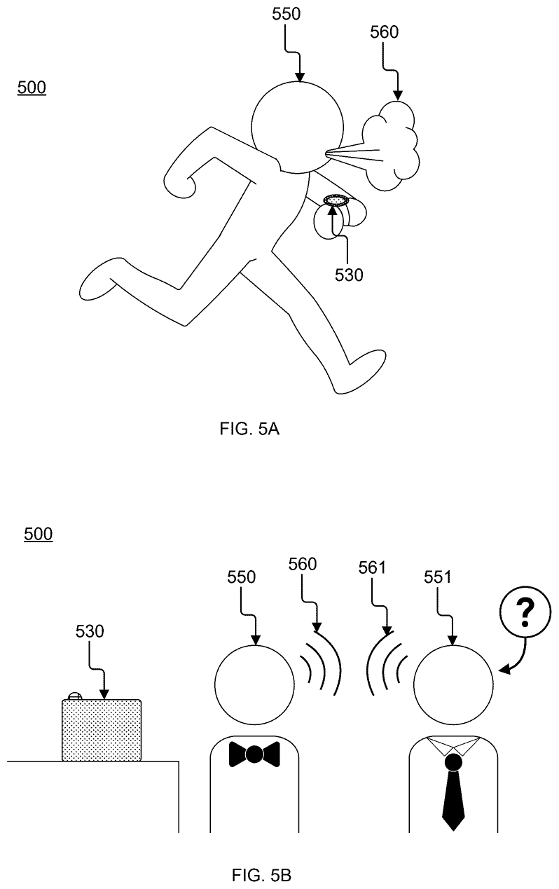

Referring now to FIGS. 5A-B, an exemplary audio analytics system 500 comprising at least one training source 560, 561, according to some embodiments of the present disclosure, is illustrated. In some aspects, the audio analytics system 500 may comprise at least one training source 560, 561. In some implementations, the audio analytics system 500 may comprise at least one audio capture device 530.

In some embodiments, the audio analytics system 500 may comprise a training source 560. In some aspects, the audio analytics system 500 may comprise an audio capture device 530. In some implementations, the audio capture device 530 may be configured to capture the training source 560 for processing or analysis by the audio analytics system 500.

As a non-limiting illustrative example, an audio capture device 530 may comprise a wearable technology device, such as, for example and not limitation, smart glasses or a smartwatch, that may, in some non-limiting exemplary embodiments, be worn on the wrist of an origin 550 of a training source 560 while running or engaging in other physical activities, and the training source 560 may comprise the breathing pattern and/or breathing intensity of the origin 550. In some aspects, the breathing may be captured by the audio capture device 530 as training data that may be processed by the audio analytics system 500 to learn to identify one or more potential origin characteristics that may be associated with one or more aspects of the physical health of the origin 550, such as the lung health or breathing capacity of the origin 550, as non-limiting examples.

To further illustrate the previous example, if a plurality of audio capture devices 530 are frequently worn by a plurality of origins 550, training data comprising the breathing of the origins 550 may be continuously or regularly captured, managed, and used to generate an ever-increasing amount of training data that may allow the audio analytics system 500 to become more proficient at identifying one or more potential origin characteristics that may indicate whether an origin 550 may be experiencing breathing issues or other physical health ailments. In some embodiments, the audio analytics system 500 may analyze the breathing of a plurality of origins 550 to generate training data that may enable the audio analytics system 500 to identify one or more potential origin characteristics that may be indicative of progress in the breathing capabilities or other physical health attributes of one or more of the origins 550.

In some aspects, the audio analytics system 500 may comprise a plurality of training sources 560, 561. In some embodiments, the audio analytics system 500 may comprise at least one audio capture device 530. In some aspects, the audio capture device 530 may be configured to capture audio from a conversation between two or more origins 550, 551 of the training sources 560, 561 in the form of humans and execute at least one operation on the captured conversation to generate an amount of training data that may be used to allow the audio analytics system 500 to learn to identify one or more potential origin characteristics related to at least one of the origins 550, 551.

As a non-limiting illustrative example, at least one audio capture device 530 may be configured to capture and record conversations between two or more people in different professional settings, and the audio analytics system 500 may process or analyze one or more audio characteristics of one or more sound waves produced by the voices of a plurality of employees, administrators, service workers, patrons, and other individuals within the professional environment to generate and store an amount of training data that may be used by the audio analytics system 500 to learn to identify different potential origin characteristics associated with the audio characteristics obtained via the audio capture device 530. In some aspects, by capturing and processing or analyzing the voices of various individuals in the professional setting, a significant amount of training data may be obtained that may enable the audio analytics system 500 to become more proficient at identifying one or more potential origin characteristics associated with individuals in a professional environment, such as, for example and not limitation, the demeanor, confidence level, shyness or level of risk aversion, or intensity level of each individual, as non-limiting examples. In some implementations, by learning to identify these or similar potential origin characteristics for different types of professionals, employees, contractors, and clients or customers, the audio analytics system 500 may be able to assist in evaluating whether workplace etiquette practices are being followed, whether customers have a satisfactory experience at a business location, or whether one or more bad actors may be committing a crime at a store location, as non-limiting examples.

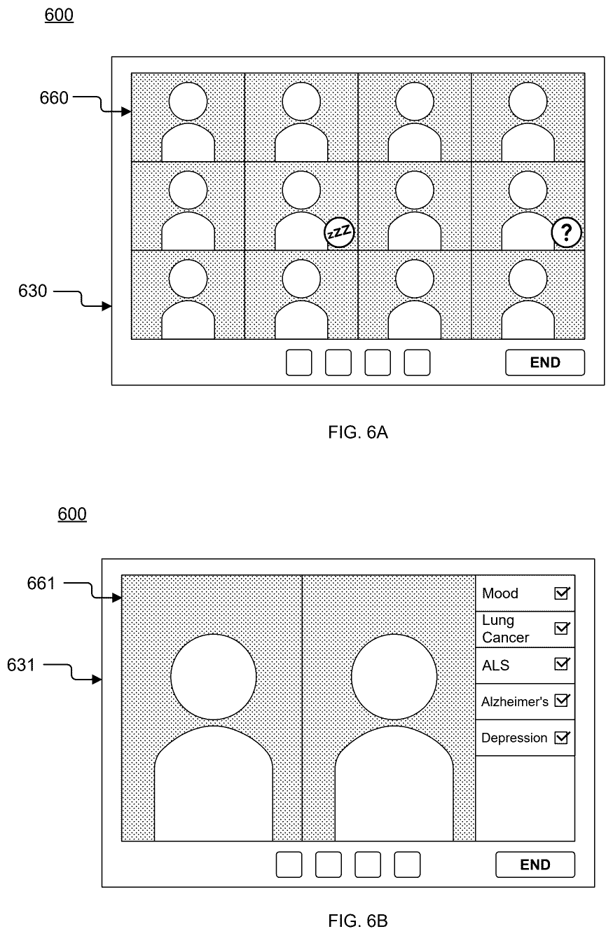

Referring now to FIGS. 6A-B, an exemplary audio analytics system 600 comprising two or more training sources 660, 661, according to some embodiments of the present disclosure, is illustrated. In some embodiments, the audio analytics system 600 may comprise at least two training sources 660, 661. In some implementations, the audio analytics system 600 may comprise at least one audio capture device 630, 631. In some aspects, the audio analytics system 600 may be configured to identify one or more potential origin characteristics related to or associated with each training source 660, 661.

In some aspects, at least one audio capture device 630 may be configured in a group setting to capture one or more training sources 660 that may be processed or analyzed by the audio analytics system 600. By way of example and not limitation, in some implementations, an audio capture device 630 may comprise a microphone or audio recorder that may be placed or configured within a physical or virtual classroom setting to capture a plurality of training sources 660 in the form of students in the class for processing or analysis by the audio analytics system 600.

To further illustrate the previous example, one or more sound waves produced by the students may be captured and processed or analyzed by the audio analytics system 600 to generate training data that may be stored in at least one database associated with or communicatively coupled to the audio analytics system 600, wherein the audio analytics system 600 may be able to use the training data to become more proficient at identifying one or more potential origin characteristics for one or more students that may be indicative of attentiveness, Lexile level, or understanding. By way of example and not limitation, based on previously obtained and processed training data, the audio analytics system 600 may be able to detect when students are speaking with a moderate intensity and tone and identify one or more potential origin characteristics of such students comprising an indication that those students are confident in what they are saying, suggesting they are paying attention and are comprehending what is being taught, while students who are detected speaking with a higher pitch may cause the audio analytics system 600 to identify one or more potential origin characteristics indicating that those students may be confused or unsure of their statements, suggesting a lack of understanding, and the detection of persistent laughter or slow, methodic breathing may be cause the audio analytics system 600 to identify one or more potential origin characteristics indicating that one or more of the students may be inattentive or sleeping.

In some implementations, at least one audio capture device 631 may be configured in a doctor-patient setting or other clinical environment to capture one or more training sources 661 in the form of clinical discussions between patients, doctors, or other medical professionals that may be used to generate, store, and process training data for the audio analytics system 600. As a non-limiting illustrative example, an audio capture device 631 may be used during a physical or virtual conversation between a therapist and a patient. In some aspects, by capturing and processing or analyzing one or more sounds produced by the patient, one or more potential origin characteristics may be identified relating to the patient, such as, for example and not limitation, an emotional state of the patient, a mental state of the patient, or any other emotional, mental, or physical ailments that might be affecting the patient, wherein such identified potential origin characteristics may be at least partially based on the previously processed training data.

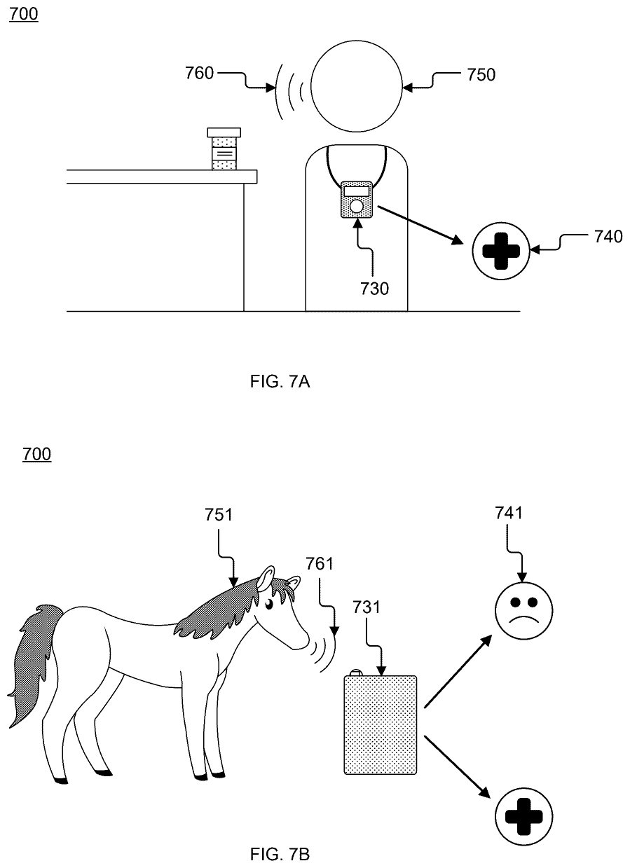

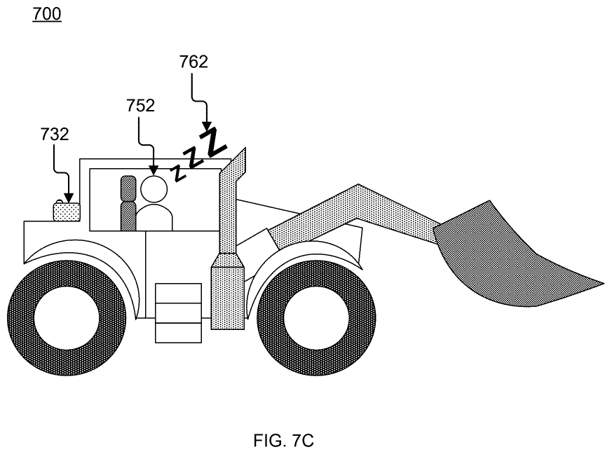

Referring now to FIGS. 7A-C, an exemplary audio analytics system 700 comprising a training source 760, 761, 762 and an audio capture device 730, 731, 732, according to some embodiments of the present disclosure, is illustrated. In some aspects, the audio analytics system 700 may comprise at least one training source 760, 761, 762. In some implementations, the audio analytics system 700 may comprise at least one audio capture device 730, 731 732. In some aspects, the audio analytics system 700 may be configured to obtain an amount of training data from the training source 760, 761, 762 that enables the audio analytics system 700 to identify and present one or more potential origin characteristics 740, 741.

In some embodiments, the audio analytics system 700 may comprise at least one training source 760. In some aspects, the audio analytics system 700 may comprise at least one audio capture device 730 configured in a residence, such as a house or apartment. In some implementations, the audio analytics system 700 may be configured to obtain an amount of training data from the training source 760 received by the audio capture device 730 that may enable the audio analytics system 700 to become more proficient at identifying one or more potential origin characteristics 740 for an origin 750 of the training source 760. In some embodiments, the audio capture device 730 may be configured to capture audio in the form of one or more sound waves produced by the training source 760 to generate, store, and process training data that may enable the audio analytics system 700 to identify one or more potential origin characteristics 740 that may be applicable to one or more types of home safety monitoring.

As a non-limiting illustrative example, an audio capture device 730 may comprise a wearable technology device, such as smart glasses, a smartwatch, or a device worn on a necklace, as non-limiting examples, or the audio capture device 730 may be fixed or otherwise configured in a centralized location, such as by being mounted on a wall or placed on a table, as non-limiting examples. In some aspects, the configuration or placement of the audio capture device 730 may facilitate the capture of one or more training sources 760 from which an amount of training data may be derived, wherein each training source 760 may comprise one or more sound waves emitted from one or more origins 750 that may be indicative of an emergency, such as, for example and not limitation, a fire, burglary, or health event.

To further illustrate the previous example, an origin 750 may encounter a sudden onset of difficult or labored breathing, which may be a symptom of a heart attack, and, by having previously captured and processed this type of breathing and having learned to associate the breathing with a confirmed or potential heart attack, especially when the breathing may have been captured from a plurality of origins 750, the audio analytics system 700 may be configured to identify one or more potential origin characteristics 740 that indicate that the origin 750 is currently experiencing or is likely to soon experience a heart attack, and therefore the audio analytics system 700 may be able to alert one or more relevant authorities or emergency contacts to obtain potentially lifesaving medical attention for the origin 750 in a timely fashion.

In some implementations, at least one audio capture device 731 may be configured to capture, store, and process an amount of training data derived from at least one training source 761 that comprises one or more sound waves emitted from at least one origin 751. In some aspects, the audio analytics system 700 may use the training data to learn to identify one or more potential origin characteristics 741 for one or more audio sources that may be similar to the training source 761. As a non-limiting illustrative example, the training source 761 may comprise one or more sound waves produced by one or more origins 751 in the form of animals, wherein the audio analytics system 700 may compile and process training data from a plurality of animals to learn to identify one or more potential origin characteristics 741 for one or more types of animals.

As a non-limiting illustrative example, a user of the audio analytics system 700 may own an animal, and the user may place an audio capture device 731 in the vicinity of the animal so that the audio capture device 731 may capture a variety of sound waves produced by the animal that may be processed to train the audio analytics system 700 to identify one or more potential origin characteristics 741 that may comprise different emotional or mental states, or physical manifestations, that may be experienced by the animal.

To further illustrate the previous example, the audio capture device 731 may capture audio comprising all of the neighs and whinnies from a horse, and by processing those sounds, the audio analytics system 700 may be trained to be able to identify one or more potential origin characteristics 741 that may indicate why the horse is making certain noises. By way of example and not limitation, the identified potential origin characteristics 741 may indicate that the horse is neighing because it is happy or sad, or that it is whinnying because it is hungry or in pain.

In some embodiments, at least one audio capture device 732 may be configured to capture at least one training source 762 that may comprise one or more sound waves that may be used to generate an amount of training data to allow the audio analytics system 700 to learn to identify one or more potential origin characteristics that may comprise an incapacitated or otherwise distracted state for an origin 752 of each training source 762. As a non-limiting illustrative example, the at least one audio capture device 732 may be located in a vehicle or one or more types of heavy machinery, such as a forklift, and the audio capture device 732 may be configured to capture audio in the form of one or more sound waves emitted from an origin 752 that comprises the operator of the vehicle or machinery.

In some aspects, by capturing, storing, and processing sounds from previous operations of the vehicle or machinery from the same or different operators as training data, the audio capture device 732 may facilitate training of the audio analytics system 700 that may enable the audio analytics system 700 to identify one or more potential origin characteristics that may indicate that an operator of the vehicle or machinery may be asleep or otherwise incapacitated in some way.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

1. A method for preprocessing audio analytics of an audio analytics system, comprising:
receiving at least one training source, wherein the at least one training source is emitted from at least one origin and captured by an audio capture device including at least one cellular telephone system or one or more user communication services operating on one or more mobile computing devices;
storing at least one datum of training data from the training source, wherein the training data is at least temporarily stored in at least one storage medium;
propagating the at least one training source through at least one artificial intelligence infrastructure to identify at least one audio characteristic or at least one origin characteristic associated with each training source, wherein at least a portion of the training data derived from the training sources received by the audio analytics system is at least partially augmented, wherein augmenting the training data partially comprises replicating and applying one or more audio quality influencers to the training sources; and
analyzing the at least one datum of training by the at least one artificial intelligence infrastructure to improve the ability of the audio analytics system to identify one or more origin characteristics for one or more subsequently received training sources.

2. The method in claim 1, wherein the at least one artificial intelligence infrastructure executes at least one operation on one or more audio types.

3. The method of claim 1, wherein the at least one origin includes human, animal, object, or phenomenon capable of producing sound.

4. The method of claim 1, wherein the at least one artificial intelligence infrastructure receives training sources via one or more existing communication infrastructures.

5. The method of claim 4, wherein one of more components or groups of components within the one or more existing communication infrastructures is used by the audio analytics system as an audio capture device.

6. The method of claim 1, wherein the audio analytics system utilizes at least one or more of: one or more servers that host a network-based platform, one or more communication services operating on one or more mobile computing devices, one or more microphones or speakers associated with a broadcast system, one or more radio signals, or one or more microphones or speakers associated with any electronic device as audio capture devices.

7. The method of claim 1, wherein the audio analytics system is trained via at least one semi-supervised machine learning process, wherein the at least one semi-supervised machine learning process utilizes one or more pseudo-labeling techniques.

8. The method of claim 1, wherein the preprocessing audio analytics determines an accuracy of an identified origin characteristic, wherein the audio analytics system performs one or more calculations to assess a degree or a nature of an inaccuracy.

9. The method of claim 8, wherein a data set resulting from the one or more calculations is directed back through the at least one artificial intelligence infrastructure via at least one backpropagation algorithm, wherein the at least one backpropagation algorithm adjusts one or more weights, biases, or other parameters of the audio analytics system to generate accurate results for received training data obtained from one or more training services.

10. (canceled)

11. The method of claim 1, one or more audio quality influencers includes compression applied to the training sources, wherein the training sources include one or more user communication services operating on one or more computing devices.

12. The method of claim 1, wherein a determination of accuracy of the one or more origin characteristics is identified for each training source received by the audio analytics system at least partially comprises execution of at least one loss function.

13. The method of claim 12, wherein the at least one loss function is configured to determine classification loss and regression loss for each identified origin characteristics such that the audio analytics system is trained to predict at least one class or distribution range for one or more of the origin characteristics.

14. The method of claim 13, wherein the audio analytics system is trained to predict at least one class and at least one distribution range for one or more of the origin characteristics.

15. The method of claim 13, wherein the at least one loss function at least partially includes at least one semi-supervised machine learning process with pseudo-labeling techniques.

16. The method of claim 1, wherein the audio analytics system is trained to identify one or more origin characteristics for an origin of an audio source that comprise an indication of fraudulent behavior being engaged in by the origin.

17. The method of claim 16, wherein the audio analytics, having previously processed or analyzed a plurality of training sources, is configured to receive an audio source and identify origin characteristics for the origin of the audio source that comprise an indication of whether the origin is committing fraud, wherein the indication is presented via a user interface, wherein the user interface generates and presents one or more scores indicating an estimated accuracy or likelihood that the determination of fraud is accurate.

18. A system for a training data pipeline, comprising:
An electronic or digital audio capture device couplable to an internet computer network, wherein the electronic or digital audio capture device is configured to:
receive at least one training source, wherein the at least one training source is emitted from at least one origin;
at least one artificial intelligence infrastructure configured to identify at least one audio characteristic or at least one origin characteristic associated with each training source;
at least one storage medium configured to store at least one datum of training data from the training source, wherein the training data is at least temporarily stored in at least one storage medium;
at least one loss function configured to determine an accuracy of the one or more origin characteristics identified for each training source received by the electronic audio capture device, wherein at least one loss function simultaneously determines classification loss and regression loss.

19. The system of claim 18, wherein the at least one loss function is configured to determine classification loss and regression loss for each identified origin characteristics such that the training data pipeline system is configured to predict at least one class or distribution range for one or more of the origin characteristics.

20. The system of claim 19, wherein the at least one loss function at least partially includes at least one semi-supervised machine learning process with pseudo-labeling techniques.
